(19) United States
(12) Patent Application Publication
(10) Pub. No.: US 2015/0196985 A1
(43) Pub. Date: Jul. 16, 2015

(54) STEPPED SHAFT FOR SPINDLE ASSEMBLY

(71) Applicant: ENGINEERED ABRASIVES, INC., Alsip, IL (US)

(72) Inventor: Michael J. Wern, Alsip, IL (US)

(21) Appl. No.: 14/498,565

(22) Filed: Sep. 26, 2014

Related U.S. Application Data
(60) Provisional application No. 61/927,071, filed on Jan. 14, 2014.

(51) Int. Cl. B23Q 7/04

(52) U.S. Cl. CPC B23Q 7/043; B23Q 7/048

(57) ABSTRACT

The present disclosure includes a shaft and spindle assembly for retaining a part in a part processing assembly. The part is retained on the shaft via a downward force from a part hold-down assembly. The shaft is retained in the spindle assembly that is coupled to a turntable of the part processing assembly. The shaft includes an annular step that abuts against a portion of the spindle assembly to block downward movement of the shaft when the downward force is applied. In this way, the part is retained in a precise location relative to processing nozzles of the part processing assembly even after multiple parts are held down by the part hold-down assembly and processed.

### CROSS REFERENCE TO RELATED APPLICATIONS

This application claims priority under 35 U.S.C. § 119(e) to U.S. Provisional Application Ser. No. 61/927,071, filed Jan. 14, 2014, which is expressly incorporated by reference herein.

### BACKGROUND

The subject matter disclosed herein relates to a spindle assembly, and more particularly, a spindle assembly for a part processing apparatus. More particularly, the present invention includes a system and apparatus of a stepped shaft for a spindle assembly for use in retaining parts in an automatic apparatus for processing parts. The part processing apparatus is similar to the device as shown in U.S. Pat. No. 5,272,897, which is hereby incorporated by reference.

A stepped shaft for a spindle assembly may be used in an automatic part processing apparatus for fully automatically processing a part or work piece by methods such as shot peening and the like. A processing apparatus as shown in U.S. Pat. No. 5,272,897 uses a shaft and spindle assembly to hold up parts or work pieces in the apparatus, the parts positioned on the upwardly extending shaft that is held in place by the spindle assembly coupled to the bottom of the processing apparatus. A part-hold down assembly is configured to apply pressure to the parts to maintain them in a fixed position on the shaft which processing occurs. As a result of repetitive use and pressure, the shaft on which the part resides tends to slip downward in the spindle assembly. Over time, the shaft shifts downward and the part may become misaligned in the processing apparatus. The present invention is an improvement on the prior art with these potential issues.

This background information is provided to provide some information believed by the applicant to be of possible relevance to the present disclosure. No admission is intended, nor should such admission be inferred or construed, that any of the preceding information constitutes prior art against the present disclosure. Other aims, objects, advantages and features of the disclosure will become more apparent upon reading of the following non-restrictive description of specific embodiments thereof, given by way of example only with reference to the accompanying drawings.

The present disclosure provides for a stepped portion along the shaft which abuts against a secure portion of the spindle assembly when the shaft is inserted into the spindle assembly. The stepped portion of the shaft prevents downward movement of the shaft from continuous pressure on the shaft or part being processed. Thus, the present disclose provides for an improvement on an automatic apparatus for processing parts and a shaft and spindle assembly for use with the apparatus.

According to one embodiment, a shaft configured to retain a part includes an annular step that extends outward from the outside surface of the shaft. The shaft is configured to extend into an aperture of the spindle assembly to be retained in the spindle assembly and rotated there within. The annular step of the shaft is configured to have an outer circumference that is greater than the circumference of the aperture of the spindle assembly such that a portion of the annular step abuts against a portion of the spindle assembly when the shaft is inserted therein. The annular step prevents the shaft from unintended downward movement through the spindle assembly when significant and/or repeated pressure is applied to the shaft to hold the part down during processing. In this way, the part is maintained at a specific height that is predetermined for processing the part and does not slide out of alignment with the processing apparatus.

These and other advantages and features will become more apparent from the following description taken in conjunction with the drawings.

### BRIEF DESCRIPTION OF THE DRAWINGS

The present disclosure will be described hereafter with reference to the attached drawings which are given as a non-limiting example only, in which:

FIG. 1 is a perspective view of an automatic part processing apparatus for processing the part by a method such as peening, with a portion of the apparatus broken away to reveal a turntable and a set of lower spindle assemblies retaining parts to be processed, and having a part hold-down assembly constructed to apply downward pressure to the parts while processing;

FIG. 2 is a partial cross-sectional view of a portion of the spindle assembly, the part and the part hold-down assembly of FIG. 1 and showing by way of illustration and not limitation, that a shaft extends from the spindle assembly to retain the part;

FIG. 3 is a cross-sectional view similar to FIG. 2, showing in detail how a downward force on the part being processed exerts a downward force on the shaft holding the part, and showing the shaft extends through a turntable of the part processing apparatus and is retained by the spindle assembly that is fixedly coupled to the turntable to move with the turntable while still allowing rotation of the shaft there within;

FIG. 4 is a perspective view of the shaft of the present invention and showing the shaft includes an annular step around the circumference

FIG. 5 is an enlarged, cross-sectional view of the resiliant shaft and spindle assembly of FIG. 3, showing the shaft is configured to extend though an aperture of the spindle assembly and the annular step is configured to abut against an annular race that defines the aperture of the spindle assembly such that the shaft is prevented from any downward movement by the annular step; and

FIG. 6 is a side perspective view of the automatic part processing apparatus showing the part is retained on the shaft in a specific position relative to a processing nozzle and that the annular step of the shaft prevents unintended movement of the part from the specific position relative to the processing nozzle.

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

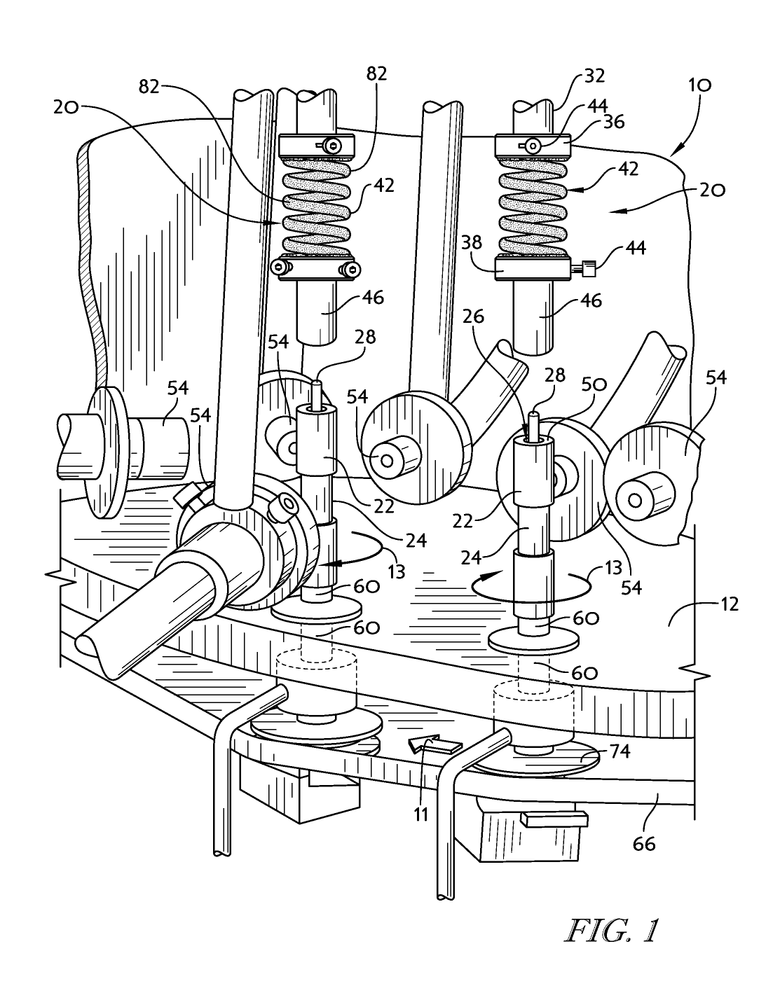

As shown in FIG. 1, a processing assembly 10 of a larger parts-processing apparatus is shown. The overall parts processing apparatus is similar to that as shown and described in U.S. Pat. No. 5,272,897, incorporated by reference herein. While the basic operation of this parts processing assembly 10 will be described hereinbelow, the primary focus of the present application will be on the structures and functions associated with a spindle assembly 62 and shaft 60 associated therewith that support a part being processed in the processing assembly 10. During use of the processing assembly 10, a part 22 can be fixtured on a support 24, as illustrated in FIG. 1. The part 22 may be of varying forms, but may typically be a hollow component, at least for the present configuration of the apparatus, having a generally cylindrical cavity 26 extending therethrough. An example of such a part 22 might include an automotive gear component. A pin 28 extends from the support 24 through the cavity 26 of the part 22 to help provide axial alignment of the components.

While not described herein, reference is made to the incorporated patent, U.S. Pat. No. 5,272,897, with regard to the operation of the overall part processing apparatus. The processing assembly 10 receives a part 22 mounted on the support 24, which is then processed in an automated manner. The processing includes automated fixturing of a part hold-down assembly 20 against the part 22, rotation of the part 22 relative to processing nozzles 54 and movement of the part 22 on a turntable 12 through a processing path. For example, one type of process used with such processing assembly 10 may be peening. As shown in FIG. 1, a series of peening nozzles 54 may be directed in a predetermined vicinity and direction of the parts 22 carried on the support 24. While the process itself is not the subject of the present application, the operation of the process is important because it highlights the need for the structures and functions of the spindle assembly 62 and the shaft 60 as disclosed herein.

As illustrated in FIG. 1, the part hold-down assembly 20 is used to hold the part 22 onto the support 24 when processing occurs in the processing assembly 10. Specifically the part hold-down assembly 20 is configured to move downward onto the part 22 and apply a downward pressure or a downward force 16 to the part 22 to retain the part 22 is a fixed position for processing. The part hold-down assembly 20 generally includes an upper collar 36, a lower collar 38, and a resilient biasing member 42. The resilient biasing member 42 is shown by way of illustration and not for limitation as a coil spring 42 or other compressive structure. The hold-down assembly 20 is carried on an upper portion of the processing assembly 10 with a shaft 32 providing a point of contact. The lower collar 38 is configured to engage with the part 22 to be processed. Specifically, an end or masking portion 46 can be attached to the corresponding lower collar 38 by use of a corresponding set screw 44, as illustrated in FIG. 1.

The part hold-down assembly 20 and its masking portion 46 apply the downward force 16 to the part 22 being processed to retain the part 22 in a fixed position while processing occurs. In addition, the masking portion 46 of the part hold-down assembly 20 may also be used to abut against a corresponding surface 50 of the part 22 in order to block or mask processing of that surface 50 of the part 22. During peening, for example, the surface 50 of the part 22 is shielded by the masking portion 46, and the peening material exiting the nozzles 54 cannot act on the surface 50 during the peening process.

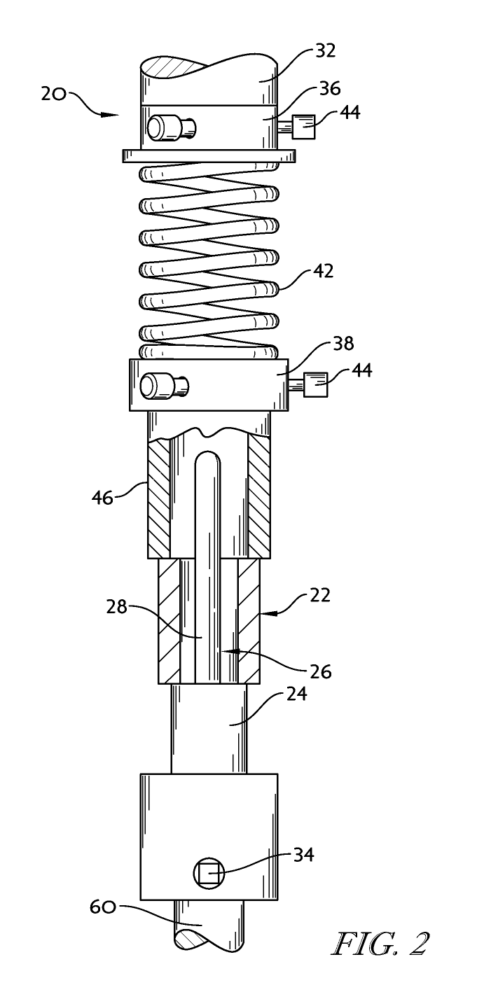

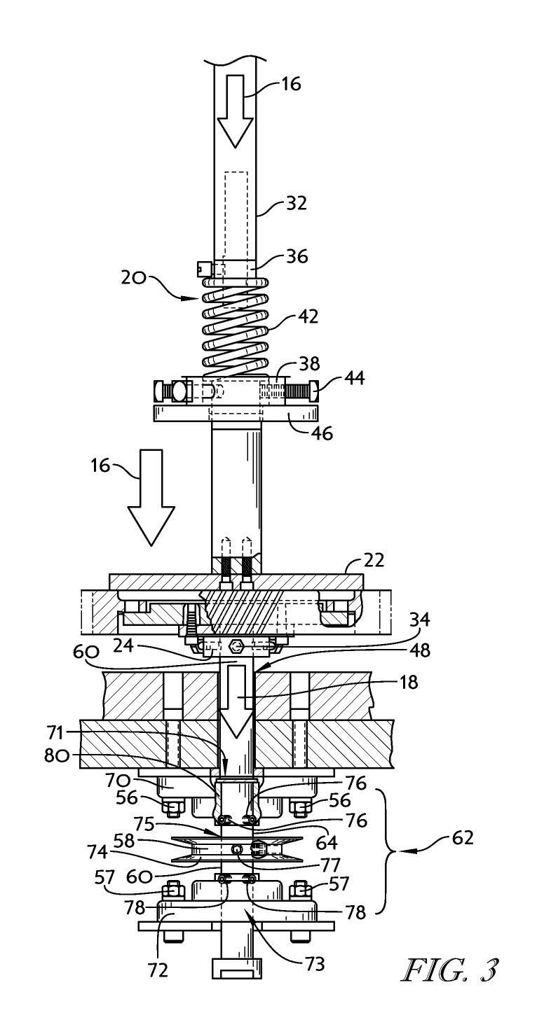

The downward force 16 applied to the part 22 by the part hold-down assembly 20 provides stability and fixed retainment of the part 22 while processing occurs. Specifically and in illustrative embodiments, the peening nozzles 54 may be configured to peen the part 22 in a precise manner that reduces the amount of excess or wasted peening material and for energy used while the peening process occurs. Therefore, placement of the part 22 relative to the peening nozzles 54 may be pre-determined to precise or specific measurements to maximize efficiency. In order to retain the part 22 in a sufficient manner and avoid unintended movement of the part 22 relative to the peening nozzles 54, a significant amount of downward force 16 is applied to the part 22 through the part hold-down assembly 20, as illustrated in FIGS. 2 and 3. This, in turn, causes significant force to be applied to the support 24 holding the part 22.

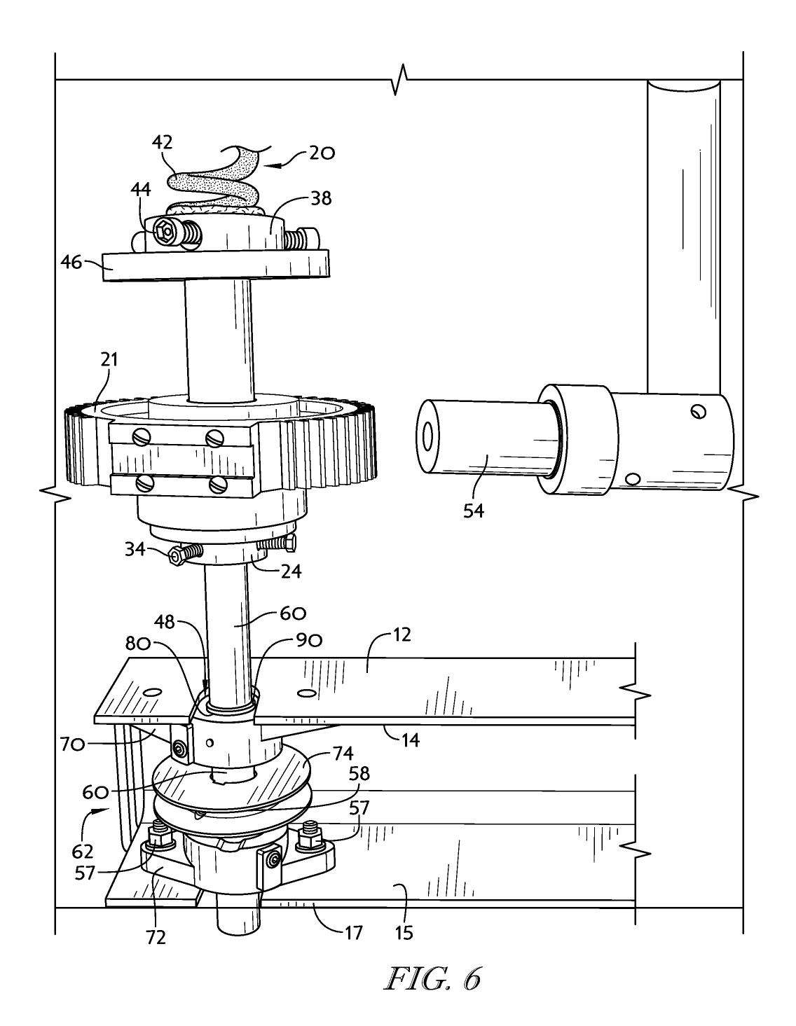

When mounted on the support 24, the part 22 is processed in the processing assembly 10 by movement of the part 22 along the processing path indicated by an arrow 11 in FIG. 1. The turntable 12 permits the part 22 to travel along the processing path 11 through the processing assembly 10. Specifically, the processing assembly 10 is configured to carry the part 22 around the processing assembly 10 by rotation of the turntable 12. The support 24 holding the part 22 is attached to the turntable 12 by a shaft 60 and one or more spindle assemblies 62, as illustrated in FIGS. 3 and 6 and described more fully below.

In addition to the turntable 12 being rotatable to carry the part 22 around the processing assembly 10, the shaft 60 is also rotatable relative to the turntable 12 in order to rotate the part 22 with respect to an individual nozzle 54, as illustrated by arrow 13 in FIG. 1. More specifically, the shaft 60 of the processing assembly 10 is configured to extend through an aperture 48 in the turntable 12 and is rotatable with respect to the turntable 12 via the spindle assembly 62 that attaches the shaft 60 to the turntable 12, as illustrated in FIGS. 1, 3 and 5. A portion of the spindle assembly 62 is fixedly attached to a bottom surface 14 of the turntable 12 to secure the spindle assembly 62 and shaft 60 with respect to the turntable 12.

In this way, the part 22 moves with the turning of the turntable 12 and travels around the processing assembly 10 to be exposed to multiple processing operations along the processing path 11. In addition, the part 22 is also movable in a rotational direction 13 during processing at each of the processing operations, the part being rotatable on the shaft 60 via the spindle assembly 62.

In illustrative embodiments, the spindle assembly 62 includes an upper bearing 70, a lower bearing 72 in spaced apart relationship to the upper bearing 70, and a pulley assembly 74, as illustrated in FIG. 5. The upper bearing 70 is configured to be secured to the bottom surface 14 of the turntable 12 by any known means, including but not limited to a set of rivets or bolts 56. The lower bearing 72 may be configured as a mirror image of the upper bearing 70 and secured to a top surface 15 of a bottom plate 17 of the processing assembly 10 that rotates with rotation of the turntable 12. The lower bearing 72 may be secured to the bottom plate 17 by any known means, including but not limited to a set of rivets or bolts 57. The pulley assembly 74 is positioned between the upper bearing 70 and the lower bearing 72. In illustrative embodiments, the upper bearing 70, the lower bearing 72, and the pulley assembly 74 are not directly coupled together, but are instead indirectly connected via engagement with the shaft 60 which extends through each of the components.

In illustrative embodiments, the shaft 60 is configured to extend, in relative order of placement, first through an aperture 71 in the upper bearing 70, second through an aperture 75 in the pulley assembly 74, and third through an aperture 73 in the lower bearing 72, as illustrated in FIGS. 3 and 5. In illustrative embodiments, the shaft 60 may be secured to the upper bearing 70, the pulley assembly 74 and the lower bearing 72 by any variety of known means. For example, the shaft 60 may be secured in the upper bearing 70 by a pair of set screws 76 extending through a portion of the upper bearing 70 (as discussed below) and into the aperture 71 to abut against the shaft 60. Similarly, the shaft 60 may be secured in the lower bearing 72 by a pair of set screws 78 extending through a portion of the lower bearing 72 and into the aperture 73 to abut against the shaft 60. The shaft 60 may be secured to the pulley assembly 74 by a pair of set screws 77 extending through the pulley assembly 74 and into the aperture 75 to abut against the shaft 60. To facilitate maintenance and replacement of the spindle assembly 62 components and the shaft 60, the set screws 76, 77, 78 may not be configured to extend through the shaft 60, but merely abut against an outer surface 64 of the shaft 60 in frictional engagement to hold the shaft 60 in fixed placement with respect to the rest of the spindle assembly 62 components.

The shaft 60 is rotatable with respect to the turntable 12 by means of the spindle assembly 62. As illustrated in FIGS. 3 and 5, the upper and lower bearings 70, 72 include an annular race 80, 82, respectively, along the inner circumference of the bearings 70, 72. The annular races 80, 82 define the apertures 71 and 73 extending through the bearings 70, 72. The annular races 80, 82 may be made of steel, in illustrative embodiments, and include apertures 84, 86 that define inner circumferences of the annular races 80, 82. As with traditional races known in the industry, the annular races 80, 82 are configured to be moveable with respect to the rest of the bearings 70, 72 and can rotate within the bearings 70, 72. For instance, the races 80, 82 may include ball bearings 81 that permit movement of the races 80, 82 with respect to the rest of the bearings 70, 72. The shaft 60 may be secured in the apertures 84, 86 of the races 80, 82 by set screws 76 and 78 such that the movement of the shaft 60 moves the races 80, 82 relative to the rest of the bearings 70, 72 when the bearings 70, 72 are coupled to and fixed secured with the turntable 12. This configuration permits rotation of the shaft 60 with respect to the turntable 12 while still allowing the shaft 60 to be connected to the turntable 12 via the spindle assembly 62.

The shaft 60 is rotated via the pulley assembly 74. The pulley assembly 74 includes a track 58 through which a belt 66 may be located to move the pulley assembly 74 in a circular rotation, as illustrated in FIGS. 1, 3 and 5. As the pulley assembly 74 is fixedly secured to the shaft 60 via the set screws 77 extending through the pulley assembly 74, rotational movement of the pulley assembly 74 rotates the shaft 60. In turn, the shaft 60 is permitted to rotate with respect to the upper and lower bearings 70, 72 in light of the annular races 80, 82 of the upper and lower bearings 70, 72.

In illustrative embodiments, the support 24 on which the part 22 is fixed is secured to the shaft 60 such that the support 24 is between the shaft 60 and the part 22. The support 24 may be attached to the shaft 60 via any known methods, including but not limited to set screws 34 that extend through the support 24 to abut against or into the shaft 60. The set screws 34 are configured to retain the support 24 in a fixed position relative to the shaft 60 and turntable 12 in order to maintain the part 22 in a precise location with respect to the processing nozzles 54 of the processing assembly 10. In this way, multiple parts 22 may be placed on the support 24 to be processed at substantially the same location and without continuous readjustment of the processing nozzles 54.

By operation, the part hold -down assembly 20 applies downward force 16 on the part 22 and support 24. In addition, part 22 also applies a downward force 16 on the support 24 due to the weight of the part 22. These forces, in combination, create a resulting downward force 18 that is applied to the shaft 60 through the set screws 34, as illustrated in FIG. 3. This downward force 18 on the shaft 60 may cause the shaft 60 to shift downward overtime, causing the shaft 60 to shift downward through the spindle assembly 62, and, more particularly, causing the shaft 60 to shift or slide through the upper and lower bearings 70, 72 of the spindle assembly 62. While the shaft 60 is secured to the upper and lower bearings 70, 72 via abutment of the set screws 76, 78 with the outer surface 64 of the shaft 60, the shaft 60 may move relative to the set screws 76, 78 when consistent downward force 18 is applied to the shaft 60 because the set screws 76, 78 merely abut against the outer surface 64 and do not extend into the shaft 60. In this way, the shaft 60 and the support 24 holding the part 22 may come out of alignment with the nozzles 54 after repeated processing of parts.

While the present disclosure is directed to any types of parts 22 being processed, it can be understood that a part 22 with more weight may cause more downward force 18 on the shaft, and can result in more slippage or sliding of the shaft 60, than a part 22 with less weight. Therefore, processing of a larger or heavier part 22 may create more frequent or substantial alignment issues as well.

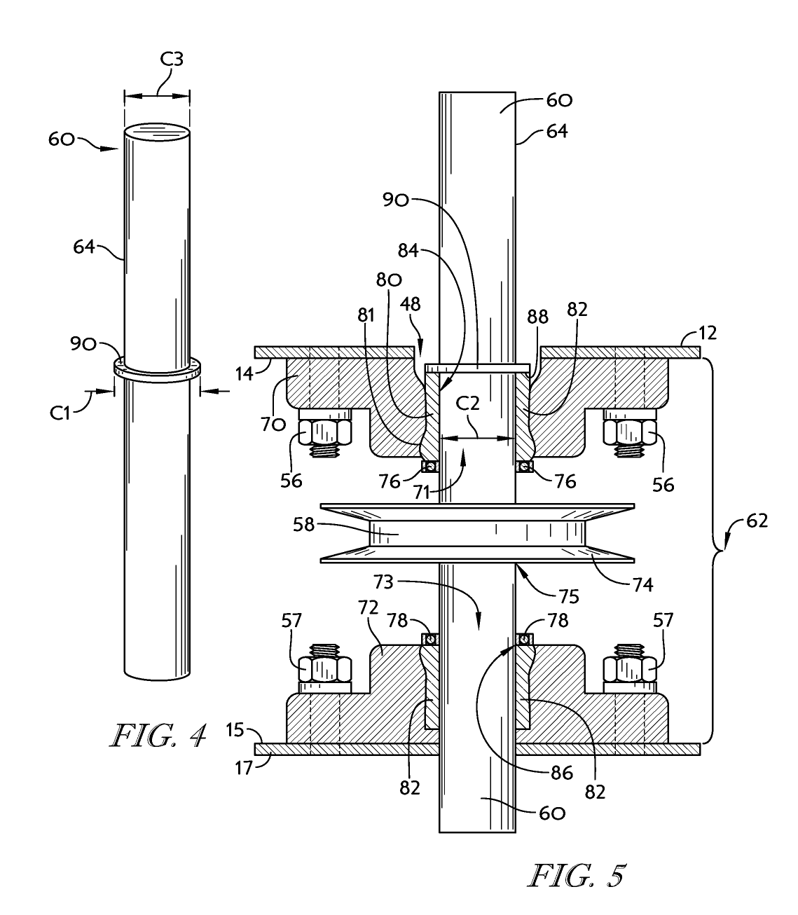

In illustrative embodiments, the shaft 60 may include an annular step 90 that extends outward from the outer surface 64 of the shaft 60, as illustrated in FIGS. 4 and 5. The annular step 90 may be located at a point above where the shaft 60 enters the aperture 84 of the race 80 to engage with the upper bearing 70. The annular step 90 may be configured to have a wider circumference C1 than an inner circumference C2 of the annular race 80 of the upper bearing 70 such that it may abut against a top surface 88 of the race 80 when the shaft 60 is inserted into the aperture 84 of the race 80 and the aperture 71 of the upper bearing 70. The annular step 90 may be of various dimensions and sizes. In illustrative embodiments, the step 90 may be 0.25 inches thick. The step 90 may also have a circumference C1 of various sizes. In illustrative embodiments, C1 may be between 0.1 inches and 1.5 inchs larger than a circumference C3 of the shaft 60. Other dimensions are envisioned as well.

The abutment of the step 90 against the top surface 88 of the annular race 80 blocks downward movement of the shaft 60 when the downward force 18 is applied to the shaft 60. When continuous downward force 16 is applied to the part 22 and the support 24 holding the part 22, the downward force 16 is converted into the downward force 18 on the shaft 60 coupled to the support 24. The downward force 18 on the shaft 60 may, in turn, be converted into a downward force on the annular step 90 as it abuts against the top surface 88 of the annular race 80 of the upper bearing 70. The top surface 88 of the annular race 80 is a solid point of contact for the annular step 90 and provides upward resistance against downward movement of the shaft 60 from the force 18. This, in turn, blocks additional downward force on the interface of the shaft 60 and the set screws 76, 78 that can cause the shaft 60 to slip or slide down when the annular step 90 is not present. In this way, the annular step 90 ensures the shaft 60, the support 24 and the part 22 on the support 24 are maintained at a precise location relative to the processing nozzles 54 in the processing assembly 10, as illustrated in FIG. 6.

By way of review, a part 22 is attached or fixed on the support 24 of the processing assembly 10, as disclosed herein and in U.S. Pat. No. 5,272,897. The part 22 is then captured between the support 24 and the part hold-down assembly 20, with the part 22 being held in a fixed position by a downward force 16 applied to the part 22 by the part hold-down assembly 20. The part hold-down assembly 20 carried on the shaft 32 is raised and lowered during the automated processing steps making axial alignment of the part hold-down assembly 20 relative to the part 22 carried on the support 24 and the application of force therethrough an important processing step. The downward force 16 applied to the part 22 creates a significant downward force 18 on a shaft 60 supporting the support 24, the shaft 60 being coupled to a turntable 12 at the bottom of the processing assembly 10.

The shaft 60 is attached to the processing assembly 10 via a spindle assembly 62 coupled to the turntable 12 of the processing assembly 10. Specifically, set screws 76, 77, 78 extend through apertures 71, 73, 75 in the spindle assembly 62 and abut against an outer surface 64 of the shaft 60, but do not extend through the shaft 60. When the downward force 18 is applied to the shaft 60 repeatedly over the course of processing many parts 22, the shaft 60 can slip down with respect to the set screws 76, 77, 78 and the spindle assembly 62.

An annular step 90 is positioned around the circumference of the shaft 60 to abut against a top portion of the spindle assembly 62. In illustrative embodiments, the annular step 90 is configured to abut against a top surface 88 of an annular steel race 80 that is part of the spindle assembly 62. The annular steel race 80 can rotate with respect to the rest of the spindle assembly 62. The outer circumference C1 of the annular step 90 is larger than the inner circumference C2 of the top surface 88 of the annular steel race 80, thus preventing the annular step 90 from moving through the aperture 84 of the annular steel race 80. The annular step 90 prevents downward movement of the shaft 60 with respect to the spindle assembly 62 when continuous or repeated downward force 18 is applied to shaft 60 during processing.

The processing operations of the processing assembly 10 may include, but is not limited to, peening operations. For example, the part 22 can be rotated on the lower support 24 connected to the shaft 60 during the processing step, during which a group of peening nozzles 54 spray peening material at the part 22 to provide processing characteristics on the surface of the part 22, in part to improve wear and durability as well as other characteristics. In order to provide the most efficient process, the part 22 should be positioned precisely with respect to the peening nozzles 54, and the location of the part 22 with respect to the peening nozzles 54 should not vary from part-to-part. The engagement of the annular step 90 of the shaft 60 with the top surface 88 of the annular race 80 prevents downward movement of the support 24 and part 22 to ensure consistent location of the part 22 during processing.

The foregoing terms as well as other terms should be broadly interpreted throughout this application to include all known as well as all hereafter discovered versions, equivalents, variations and other forms of the abovementioned terms as well as other terms. The present disclosure is intended to be broadly interpreted and not limited.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure.

1. A spindle assembly comprising:
an upper bearing assembly, the upper bearing assembly including an aperture for a shaft to extent and rotate therethrough, the aperture defined by an annular race surrounding the shaft when the shaft is inserted in the aperture;
a pulley assembly, the pulley assembly fixedly coupled to the shaft to rotate the shaft about an axis of rotation;
wherein the shaft includes an annular step which extends circumferentially outward from an outer surface of the shaft, the annular step having an outer circumference that is equal to or larger than an inner circumference the annular race of the upper bearing assembly.

2. A spindle assembly of claim 1, wherein the outer circumference of the annular step is between 0.1 and 1.5 inches away from the outer circumference of the shaft.

3. A spindle assembly of claim 1, wherein the spindle assembly further includes a lower bearing assembly that further includes an aperture for the shaft to extend and rotate therethrough.

4. A spindle assembly of claim 1, wherein the annular step is welded to the outside of the shaft.

5. A spindle assembly of claim 1, wherein the annular step is co-molded with the shaft.

6. A part processing apparatus, the part processing apparatus configured to retain parts being processed and including a spindle assembly configured to retain the part being process and configured to permit rotation of the part, the spindle assembly including a bearing assembly and a rotatable shaft that rotates within the bearing assembly, wherein the rotatable shaft includes an annular step that extends circumferentially outward from the rotatable shaft and is configured to abut against an outer edge of the bearing assembly to block movement of the shaft through the bearing assembly.
